(19) United States
(12) Patent Application Publication
(10) Pub. No.: US 2005/0256016 A1
(43) Pub. Date: Nov. 17, 2005

(54) Bleaching composition comprising a carbohydrate oxidase

(75) Inventors: Hiroshi Oh, Cincinnati, OH (US); Mike Stanford Showell, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 11/130,712

(22) Filed: May 17, 2005

Related U.S. Application Data
(60) Provisional application No. 60/571,844, filed on May 17, 2004.

(51) Int. Cl. C11D 3/00

(52) U.S. Cl. 510/312

(57) ABSTRACT

The present invention relates to detergent compositions comprising a carbohydrate oxidase enzyme and a bleaching catalyst, for effective removal of highly coloured stains and soils such as carotenoids, and/or lignin-comprising stains.

### CROSS REFERENCE TO RELATED APPLICATION

This application claims the benefit of U.S. Provisional Application No. 60/571,844, filed May 17, 2004.

### TECHNICAL FIELD

This invention relates to detergent compositions comprising a carbohydrate oxidase and a bleaching catalyst.

### BACKGROUND OF THE INVENTION

Highly coloured or ‘dried-on’ soils derived for example, from fruit and/or vegetables are particularly challenging soils to remove. These coloured stains contain highly coloured compounds based on carotenoids compounds such as α-,β- and γ-carotene and lycopene and xanthophyls (zeaxanthin or capsanthin), or porphyrins such as chlorophyll and flavonoid pigments and dye components. This latter group of natural flavonoid based dye components comprises the highly coloured anthocyanins dyes and pigments based on pelargonidin, cyanidin, delphidin and their methyl esters and the antoxanthins. These compounds are the origin of most of the orange, red, violet and blue colours occurring in fruits and are abundant in all berries, cherry, red and black currents, grapefruits, passion fruit, oranges, lemons, apples, pears, pomegranate, red cabbage, red beets, tea, coffee, and also flowers. Carotenoids soils are derived from carrots, peppers, marigold, tomatoes etc and in any processed products containing these components as well as certain tropical fruits and saffron. Carotenoid substances are also used as colorants and additives in food and animal feed as well as cosmetics. Furthermore, lignin is the major component of tea and coffee stains. Lignin is a mixture of aromatic organic polymers that produce strong dark colour.

As noted, carotenoid and lignin compounds possess intense coloration. Their use in food, cosmetics and other products leads to problems arising from this coloration. Carotene-based stains are often difficult to remove from fabrics, clothing, dishware and other material, in particular porous material. Lignin is the toughest component in tea and coffee stains to remove with conventional detergents. Conventional detergents based on chemicals such as bleaching species and enzymes, often fails to completely remove such stains. Moreover, bleaching species cannot be easily formulated into liquid or gel compositions because of their incompatibility with other ingredients such as enzymes and other organic active ingredients.

A particular problem of automatic dishwashing is that these coloured food soils may be removed from soiled articles into the wash solution, and then may be redeposited from the wash solution onto other articles in the wash or onto the interior of the dishwashing machine. The problem is particularly noticeable when the wash load includes articles soiled by foods naturally containing significant levels of coloured dyestuff molecules, including for example tomato sauce and curry. The Applicant has found that plastic articles in the wash, and especially areas of the interior of the dishwashing machine which are made of plastic material, are particularly susceptible to the staining/discolouration of the dishware by coloured food soils. Said soils can interact with the surface of such plastic substrates producing staining which can be very difficult to remove.

Accordingly, there is a need for an improved detergent composition providing effective highly coloured stains and soils removal. It is a further object of the present invention to formulate dishwashing compositions preventing the staining/discolouration of the dishware by highly coloured components.

The above objectives have been met by formulating detergent compositions comprising a carbohydrate oxidase enzyme and a bleaching catalyst.

U.S. Pat. No. 5,288,746 describes liquid laundry detergent compositions containing glucose and glucose oxidase for generation of hydrogen peroxide during the laundering process. Cu²⁺ and Ag²⁺ ions are included to prevent premature hydrogen peroxide generation in the composition. Such compositions also contain a bleach catalyst to facilitate bleaching by the hydrogen peroxide. WO95/29996 relates to an alkaline glucose oxidase and its use in bleaching and detergent compositions as a source of hydrogen peroxide, preferably with a peroxidase and more preferably with a peroxidase and an oxidizable substrate such as a phenolic compound e.g. p-hydroxybenzenesulfonate. DE2,557,623 discloses detergent compositions comprising surfactants, builders and enzymes and which catalyse the oxidation of an appropriate substrate in the presence of the oxygen of the air with the formation of hydrogen peroxide, characterised that such compositions comprise uratoxidase with uric acid, galactose oxidase with galactose, and/or alcohol oxidase with alcohols and or ketoalcohols whereby the oxidase is present in amounts of 0.3-10% wt, the substrate is present in amounts of 3-30% wt and the composition has a pH of 8.5-11.

### SUMMARY OF THE INVENTION

The present invention relates to detergent compositions comprising a carbohydrate oxidase enzyme and a bleaching catalyst, for effective removal of highly coloured stains and soils such as carotenoids, and/or lignin-comprising stains.

In a preferred embodiment, the present invention relates to a dishwashing composition, preferably an automatic dishwashing composition comprising a carbohydrate oxidase enzyme and a bleaching catalyst. Such dishwashing compositions further prevent the staining/discolouration of the dishware and plastic components of the dishwasher by highly coloured components.

In another embodiment, the present invention relates to the use of a carbohydrate oxidase enzyme and a bleaching catalyst, for effective removal of highly coloured stains and soils.

### DETAILED DESCRIPTION OF THE INVENTION

It has been found that detergent compositions of the present invention comprising a carbohydrate oxidase enzyme and a bleaching catalyst, provide a highly effective system for the removal of highly coloured stains. Indeed:

First of all, the carbohydrate oxidases of the present invention are reacting with a broad range of different carbohydrate susbstates and are therefore capable of tackling soils of many different compositions. Also, no enzymatic substrate is required within the composition of the present invention since the carbohydrate oxidase uses the hydrolyzed small fragments of starch, cellulose, heme-cellulose, pectins, and sugars found in the soils and stains. Stains such as tea, coffee and tomato stains are indeed quite rich in carbohydrates. In addition, when the compositions of the present invention are in the liquid form, they do not need to be stabilised against early generation of hydrogen peroxide in the product since such detergent compositions do not contain the substrate of the carbohydrate oxidase. Furthermore, the incompatibility problems occurring when bleaching species must be formulated within liquid detergent compositions is avoided since the carbohydrate oxidase does not require a source of hydrogen peroxide; hydrogen peroxide being generated in situ during use. Finally, the bleaching catalyst of the present invention significantly enhances the bleaching performance of the generated hydrogen peroxide to provide excellent highly coloured soils removal.

Without wishing to be bound by theory, it is believed that since the hydrogen peroxide is generated from the soils on the surface of the dishware or fabric, it has therefore a higher surface activity for bleaching performance than when the hydrogen peroxide is generated in the wash solution such as with conventional bleaching systems. In presence of oxygen dissolved in the wash solution, the carbohydrate oxidase reacts with carbohydrates present in the soils and stains and generates hydrogen peroxide. As hydrogen peroxide is consumed by reaction with other materials e.g. in the bleaching of stains present on fabrics or dishware; more hydrogen peroxide is enzymatically produced.

The Carbohydrate Oxidase Enzyme

The detergent composition of the present invention comprise a carbohydrate oxidase, i.e. an enzyme which catalyzes the oxidation of carbohydrate substrates such as carbohydrate monomers, di-mers, tri-mers, or oligomers and reduces molecular oxygen to generate hydrogen peroxide.

Suitable carbohydrate oxidases for the present invention are aldose oxidase, galactose oxidase (IUPAC classification EC1.1.3.9), cellobiose oxidase (IUPAC classification EC1.1.3.25), pyranose oxidase (IUPAC classification EC1.1.3.10), sorbose oxidase (IUPAC classification EC1.1.3.11) and/or hexose oxidase (IUPAC classification EC1.1.3.5). Glucose oxidase (IUPAC classification EC1.1.3.4) is not encompassed within the present invention. Glucose oxidase is a highly specific enzyme that reacts only on the substrate D-Glucose. In contrast, the carbohydrate oxidases of the present invention have a significantly broader substrate specificity and therefore are capable of removing carbohydrates more efficiently and a broader spectrum of carbohydrates. For example: Galactose oxidase reacts on D-Galactose, lactose, melibiose, raffinose and stachyose; Cellobiose oxidase reacts on cellobiase, and also on cellodextrins, lactose, and D-mannose; Pyranose oxidase reacts on D-Glucose, and also on D-Xylose, L-Sorbose, and D-Glucose-1. 5-lactose; Sorbose oxidase reacts on L-Sorbose, and also on D-Glucose, D-Galactose and D-Xylose; Hexose oxidase reacts on D-Glucose, and also D-Galactose, D-Mannose, malton, lactose, and cellobiase.

By studying EC 1.1.3._, EC 1.2.3._, EC 1.4.3._, and EC 1.5.3._or similar classes based on the recommendations of the Nomenclature Committee of the International Union of Biochemistry and Molecular Biology (IUBMB), other examples of useful carbohydrate oxidases are easily recognized by one skilled in the art.

Preferred carbohydrate oxidases of the present invention are aldose oxidase and/or galactose oxidase, more preferably is the aldose oxidase because of its broadest substrate specificity. Aldose oxidase is active on all mono-, di-, tri- and oligo-carbohydrates such as D-arabinose, L-arabinose, D-Cellobiose, 2-Deoxy-D-galactose, 2-Deoxy-D-ribose, D-Fructose, L-Fucose, D-Galactose, D-glucose, D-glycero-D-gulo-heptose, D-lactose, D-Lyxose, L-Lyxose, D-Maltose, D-Mannose, Melezitose, L-Melibiose, Palatinose, D-Raffinose, L-Rhamnose, D-Ribose, L-Sorbose, Stachyose, Sucrose, D-Trehalose, D-Xylose, L-Xylose.

Suitable hexose oxidases are described in WO96/39851 published by Danisco on Dec. 19, 1996, in examples 1 to 6. Suitable pyranose oxidase are described in WO97/22257 published by Novo Nordisk A/S on Jun. 26, 1997, on page 1, line 28 to page 2, linel9, on page 4, line 13 to page 5 line 14 and on page 10, line 35 to page 11, line 24.

A suitable carbohydrate oxidase is the aldose oxidase described in WO99/31990 published on Jul. 1, 1999 by Novo Nordisk A/S, being a polypeptide produced by Microdochium nivale CBS 100236 or having the amino acid sequence therein described in SEQ ID NO:2 or an analogue thereof.

The carbohydrate oxidase is comprised at a level of 0.0001% to 2%, preferably from 0.001% to 0.2%, more preferably from 0.005% to 0.1% pure enzyme by weight of the total composition.

For example, Galactose oxidase is commercially available from Novozymes A/S; Cellobiose oxidase from Fermco Laboratories, Inc. (USA); Galactose Oxidase from Sigma; Pyranose oxidase from Takara Shuzo Co. (Japan); Sorbose oxidase from ICN Pharmaceuticals, Inc (USA), and Glucose Oxidase from Genencor International, Inc. (USA).

Even if not required in the compositions of the present invention, substrates like sugar, glucose and galactose can be added to further enhance the enzymatic bleaching performance.

The Bleaching Catalyst

The compositions herein comprise a bleaching catalyst which is capable of catalysing the bleaching activity of the hydrogen peroxide generated by the carbohydrate oxidase in aqueous media. Suitable bleaching catalysts for the purpose of the present invention are metal-containing bleaching catalyst, bleach activator and/or peroxidases, preferably is a metal-containing bleaching catalyst.
1) Peroxidase or Haloperoxidase and Compounds Exhibiting Peroxidase or Haloperoxidase Activity

A suitable bleaching catalyst for the present invention is a peroxidase, a haloperoxidase and/or a compound exhibiting peroxidase and/or haloperoxidase activity (all hereinafter referred to as “peroxidase”). When encompassed, the peroxidase is comprised at a level of 0.0001% to 2%, preferably from 0.001% to 0.2%, more preferably from 0.005% to 0.1% pure enzyme by weight of the total composition.

The compound exhibiting peroxidase activity may be any peroxidase enzyme comprised by the enzyme classification EC 1.11.1.7, or any fragment derived therefrom, exhibiting peroxidase activity. In the context of this invention, compounds exhibiting peroxidase activity comprise peroxidase enzymes and peroxidase active fragments derived from cytochromes or haemoglobin.

Preferably, the peroxidase is producible by plants (e.g. horseradish or soybean peroxidase) or microorganisms such as fungi or bacteria.

Some preferred fungi include strains belonging to the subdivision Deuteromycotina, class Hyphomycetes, e.g., Fusarium, Humicola, Trichoderma, Myrothecium, Verticillum, Arthromyces, Caldariomyces, Ulocladium, Embellisia, Cladosporium or Dreschlera, in particular Fusarium oxysporum (DSM 2672), Humicola insolens, Trichoderma resii, Myrothecium verrucaria (IFO 6113), Verticillum alboatrum, Verticillum dahlie, Arthromyces ramosus (FERM P-7754), Caldariomyces fumago, Ulocladium chartarum, Embellisia alli or Dreschlera halodes. Other preferred fungi include strains belonging to the subdivision Basidiomycotina, class Basidiomycetes, e.g., Coprinus, Phanerochaete, Coriolus or Trametes, in particular Coprinus cinereus f.microsporus (IFO 8371), Coprinus macrorhizus, Phanerochaete chrysosporium (e.g. NA-12) or Trametes (previously called Polyporus), e.g., T. versicolor (e.g. PR4 28-A). Further preferred fungi include strains belonging to the subdivision Zygomycotina, class Mycoraceae, e.g., Rhizopus or Mucor, in particular Mucor hiemalis.

Some preferred bacteria include strains of the order Actinomycetales, e.g. Streptomyces spheroides (ATTC 23965), Streptomyces thermoviolaceus (IFO 12382) or Streptoverticillum verticillium. Other preferred bacteria include Bacillus pumilus (ATCC 12905), Bacillus stearothermophilus, Rhodobacter sphaeroides, Rhodomonas palustri, Streptococcus lactis, Pseudomonas purrocinia (ATCC 15958) or Pseudomonas fluorescens (NRRL B-11). Further preferred bacteria include strains belonging to Myxococcus, e.g., M. virescens.”

Determination of Peroxidase Activity (POXU)

One peroxidase unit (POXU) is the amount of enzyme which under the following conditions catalyses the conversion of 1 micromole hydrogen peroxide per minute: 0.1 M phosphate buffer pH 7.0, 0.88 mM hydrogen peroxide, 1.67 mM 2,2′-azino-bis(3-ethylbenzothiazoline-6-sulfonate) (ABTS) at 30° C. The reaction is followed for 60 seconds (15 seconds after mixing) by the change in absorbance at 418 nm, which should be in the range 0.15 to 0.30. For calculation of activity is used an absorption coefficient of oxidized ABTS of 36 mM⁻¹ cm⁻¹ and a stoichiometry of one micromole H₂O₂ converted per two micromole ABTS oxidized.

The haloperoxidases suitable for the invention include chloroperoxidases, bromoperoxidases and compounds exhibiting chloroperoxidase or bromoperoxidase activity. Haloperoxidases form a class of enzymes, which are capable of oxidizing halides (Cl—, Br—, I—) in the presence of hydrogen peroxide or a hydrogen peroxide generating system to the corresponding hypohalous acid.

Haloperoxidases are classified according to their specificity for halide ions: Chloroperoxidases which catalyze formation of hypochlorite from chloride ions, hypobromite from bromide ions and hypoiodite from iodide ions; and bromoperoxidases which catalyze formation of hypobromite from bromide ions and hypoiodite from iodide ions. Hypoiodite, however, undergoes spontaneous disproportionation to iodine and thus iodine is the observed product. These hypohalite compounds may subsequently react with other compounds forming halogenated compounds.

Haloperoxidases have been isolated from various organisms: mammals, marine animals, plants, algae, lichen, fungi and bacteria. Haloperoxidases have been isolated from many different fungi, in particular from the fungus group dematiaceous hyphomycetes, such as Caldariomyces, e.g., C. fumago, Alternaria, Curvularia, e.g., C. verruculosa and C. inaequalis, Drechslera, Ulocladium and Botrytis. Haloperoxidases have also been isolated from bacteria such as Pseudomonas, e.g., P. pyrrocinia and Streptomyces, e.g., S. aureofaciens.

In a preferred embodiment the haloperoxidase is a vanadium haloperoxidase (i.e. a vanadium or vanadate containing haloperoxidase) derivable from Curvularia sp., in particular Curvularia verruculosa and Curvularia inaequalis, such as C. inaequalis CBS 102.42 as described in WO 95/27046, e.g. a vanadium haloperoxidase encoded by the DNA sequence of WO 95/27046, FIG. 2; or Curvularia verruculosa CBS 147.63 or Curvularia verruculosa CBS 444.70 both described in WO 97/04102 published on Feb. 6, 1997 by Novo Nordisk A/S (examples 1, 3-17, 19-21 and corresponding sequences). Also preferred is the vanadium chloroperoxidase derivable from Drechslera hartlebii as described in WO 01/79459, Dendryphiella salina as described in WO 01/79458, Phaeotrichoconis crotalarie as described in WO 01/79461, or Geniculosporium sp. as described in WO 01/79460. The vanadium haloperoxidase is more preferably derivable from Drechslera hartlebii (DSM 13444), Dendryphiella salina (DSM 13443), Phaeotrichoconis crotalarie (DSM 13441) or Geniculosporium sp. (DSM 13442). Another preferred Vanadium haloperoxidase is described in WO01/11969 page 6, lines 13 to page 7, line 12. Methods for production of haloperoxidases is extensively described in WO92/16634 published on Oct. 1, 1992 and in WO93/19195 published on Sep. 30, 1993, both by Novo Nordisk A/S

Determination of Haloperoxidase Activity

A microtiter assay may be used to measure haloperoxidase activity by mixing 100 μl of haloperoxidase sample (about 0.2 μg/ml) and 100 μl of 0.3 M sodium phosphate pH 7 buffer, 0.5 M potassium bromide and 0.008% phenol red; adding the solution to 10 μl of 0.3% H₂O₂, and measuring the absorption at 595 nm as a function of time.

Another haloperoxidase assay uses monochlorodimedone (Sigma M4632, ε=20000 M⁻cm⁻¹ at 290 nm) as a substrate. The assay is done in an aqueous solution of 0.1 M sodium phosphate or 0.1 M sodium acetate, 50 μM monochlorodimedone, 10 mM KBr/KCl, 1 mM H₂O₂ and a haloperoxidase concentration of about 1 μg/ml. The decrease in absorption at 290 nm is measured as a function of time.

Preferably the ratio of carbohydrate oxidase to peroxidase—expressed in weight of pure enzyme—is ranging from 10:1 to 1:10, more preferably is 1:1.

Commercially available peroxidases are Lignin peroxidase (Ligninase), Horseradish oxidase, and Manganese oxidase from EOE Inc' (USA) or from Sigma.

The peroxidase enzyme activity can be boosted by the presence of an enhancing agent. Suitable enhancing agents are described on pages 7 to 16 of WO 02/47483. Preferred enhancing agents are alkylsyringates (formulas IV and V) and phenoxazines/phenothiazines (formula VII).

2) Bleach Activators

A second suitable bleaching catalyst for the present invention is a bleach activator (peracid precursor). When encompassed, the bleach activator is present at levels of from 0.01%, preferably from 0.5%, more preferably from 1% to 15%, preferably to 10%, more preferably to 8%, by weight of the composition. A bleach activator as used herein is any compound which when used in conjunction with a hydrogen peroxide source leads to the in situ production of the peracid corresponding to the bleach activator. Various non limiting examples of activators are fully disclosed in U.S. Pat. No. 5,576,282, U.S. Pat. No. 4,915,854 and U.S. Pat. No. 4,412,934. See also U.S. Pat. No. 4,634,551 for other typical bleaches and activators useful herein.

Preferred activators are selected from the group consisting of tetraacetyl ethylene diamine (TAED), benzoylcaprolactam (BzCL), 4-nitrobenzoylcaprolactam, 3-chlorobenzoylcaprolactam, benzoyloxybenzenesulphonate (BOBS), nonanoyloxybenzenesulphonate (NOBS), phenyl benzoate (PhBz), decanoyloxybenzenesulphonate (C₁₀-OBS), benzoylvalerolactam (BZVL), octanoyloxybenzenesulphonate (C₈—OBS), perhydrolyzable esters and mixtures thereof, most preferably benzoylcaprolactam and benzoylvalerolactam. Particularly preferred bleach activators in the pH range from 8 to 11 are those selected having an OBS or VL leaving group.

Preferred hydrophobic bleach activators include, but are not limited to, nonanoyloxybenzenesulphonate (NOBS), 4-[N-(nonaoyl) amino hexanoyloxy]-benzene sulfonate sodium salt (NACA-OBS) an example of which is described in U.S. Pat. No. 5,523,434, dodecanoyloxybenzenesulphonate (LOBS or C₁₂-OBS), 10-undecenoyloxybenzenesulfonate (UDOBS or C₁₁-OBS with unsaturation in the 10 position), and decanoyloxybenzoic acid (DOBA).

The mole ratio of peroxygen source (as AvO) to bleach activator in the present invention generally ranges from at least 1:1, preferably from 20:1, more preferably from 10:1 to 1:1, preferably to 3:1.

Quaternary substituted bleach activators may also be included: a quaternary substituted bleach activator (QSBA) or a quaternary substituted peracid (QSP, preferably a quaternary substituted percarboxylic acid or a quaternary substituted peroxyimidic acid); more preferably, the former. Preferred QSBA structures are further described in U.S. Pat. No. 5,686,015 Willey et al., issued Nov. 11, 1997; U.S. Pat. No. 5,654,421 Taylor et al., issued Aug. 5, 1997; U.S. Pat. No. 5,460,747 Gosselink et al., issued Oct. 24, 1995; U.S. Pat. No. 5,584,888 Miracle et al., issued Dec. 17, 1996; U.S. Pat. No. 5,578,136 Taylor et al., issued Nov. 26, 1996.

Highly preferred bleach activators useful herein are amide-substituted as described in U.S. Pat. No. 5,698,504, U.S. Pat. No. 5,695,679, and U.S. Pat. No. 5,686,014. Preferred examples of such bleach activators include: (6-octanamidocaproyl)oxybenzenesulfonate, (6-nonanamidocaproyl) oxybenzenesulfonate, (6-decanamidocaproyl)oxybenzenesulfonate and mixtures thereof.

Other useful activators, disclosed in U.S. Pat. No. 5,698,504, U.S. Pat. No. 5,695,679, U.S. Pat. No. 5,686,014 each of which is cited herein above and U.S. Pat. No. 4,966,723Hodge et al., issued Oct. 30, 1990, include benzoxazin-type activators, such as a C₆H₄ ring to which is fused in the 1,2-positions a moiety —C(O)OC(R¹)═N—.

Nitriles, such as acetonitriles and/or ammonium nitrites and other quaternary nitrogen containing nitrites, are another class of activators that are useful herein. Nonlimiting examples of such nitrile bleach activators are described in U.S. Pat. Nos. 6,133,216, 3,986,972, 6,063,750, 6,017,464, 5,958,289, 5,877,315, 5,741,437, 5,739,327, 5,004,558; EP Nos. 790 244, 775 127, 1 017 773, 1 017 776; and WO 99/14302, WO 99/14296, WO96/40661.

Depending on the activator and precise application, good bleaching results can be obtained from bleaching systems having an in-use pH of from 6 to 13, preferably from 8.0 to 10.5. Typically, for example, activators with electron-withdrawing moieties are used for near-neutral or sub-neutral pH ranges. Alkalis and buffering agents can be used to secure such pH.

Acyl lactam activators, as described in U.S. Pat. No. 5,698,504, U.S. Pat. No. 5,695,679 and U.S. Pat. No. 5,686,014, are very useful herein, especially the acyl caprolactams (see for example WO 94-28102 A) and acyl valerolactams (see U.S. Pat. No. 5,503,639 Willey et al., issued Apr. 2, 1996).

3) Metal-containing Bleach Catalysts—A further suitable and preferred bleaching catalyst of the compositions and methods of the present invention include metal-containing bleach catalysts, preferably manganese and cobalt-containing bleach catalysts. Preferred combinations of the present invention are the combination of a carbohydrate oxidase, preferably an aldose oxidase with 5,12-diethyl-1,5,8,12-tetraazabicyclo [6,6,2] hexadecane, dichloride, Mn(II) salt and/or with Pentaamine acetate cobalt(III) salt; those preferably for use in dishwashing, more preferably automatic dishwashing and further preferably in a liquid composition.

One type of metal-containing bleach catalyst is a catalyst system comprising a transition metal cation of defined bleach catalytic activity, such as copper, iron, titanium, ruthenium tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra (methylenephosphonic acid) and water-soluble salts thereof. Such catalysts are disclosed in U.S. Pat. No. 4,430,243 Bragg, issued Feb. 2, 1982.

Manggnese Metal Complexes—If desired, the compositions herein can be catalyzed by means of a manganese compound. Such compounds and levels of use are well known in the art and include, for example, the manganese-based catalysts disclosed in U.S. Pat. Nos. 5,576,282; 5,246,621; 5,244,594; 5,194,416; and 5,114,606; and European Pat. App. Pub. Nos. 549,271 A1, 549,272 A1, 544,440 A2, and 544,490 A1; Preferred examples of these catalysts include Mn^{IV}₂(u-O)₃(1,4,7-trimethyl-1,4,7-triazacyclononane)₂(PF₆)₂, Mn^{III}₂(u-O)₁(u-OAc)₂(1,4,7-trimethyl-1,4,7-triazacyclononane)₂(ClO₄)₂, Mn^{IV}₄(u-0)₆(1,4,7-triazacyclononane)₄(ClO₄)₄, Mn^{III-}Mn^{IV}₄(u-O)₁(u-OAC)₂-(1,4,7-trimethyl-1,4,7-triazacyclononane)₂(ClO₄)₃, Mn^{IV}(1,4,7-trimethyl-1,4,7-triazacyclononane)-(OCH₃)₃(PF₆), and mixtures thereof. Other metal-based bleach catalysts include those disclosed in U.S. Pat. Nos. 4,430,243 and U.S. Pat. No. 5,114,611. The use of manganese with various complex ligands to enhance bleaching is also reported in the following: U.S. Pat. Nos. 4,728,455; 5,284,944; 5,246,612; 5,256,779; 5,280,117; 5,274,147; 5,153,161; and 5,227,084.

Cobalt Metal Complexes—Cobalt bleach catalysts useful herein are known, and are described, for example, in U.S. Pat. Nos. 5,597,936; 5,595,967; and 5,703,030; and M. L To be, “Base Hydrolysis of Transition-Metal Complexes”, Adv. Inorg. Bioinorz. Mech., (1983), 2, pages 1-94. The most preferred cobalt catalyst useful herein are cobalt pentaamine acetate salts having the formula [Co(NH₃)₅OAc] T_{y}, wherein “OAc” represents an acetate moiety and “T_{y}” is an anion, and especially cobalt pentaamine acetate chloride, [Co(NH₃)₅OAc]Cl₂; as well as [Co(NH₃)₅OAc](OAc)₂; [Co(NH₃)₅OAc](PF₆)₂; [Co(NH₃)₅OAc](SO₄); [Co(NH₃)₅OAc](BF₄)₂; and [Co(NH₃)₅OAc](NO₃)₂ (herein “PAC”).

These cobalt catalysts are readily prepared by known procedures, such as taught for example in U.S. Pat. Nos. 6,302,921, 6,287,580, 6,140,294, 5,597,936; 5,595,967; and 5,703,030; in the To be article and the references cited therein; and in U.S. Pat. No. 4,810,410; J. Chem. Ed. (1989), 66 (12), 1043-45; The Synthesis and Characterization of Inorganic Compounds, W. L. Jolly (Prentice-Hall; 1970), pp. 461-3; Inorg. Chem. 18, 1497-1502 (1979); Inorg. Chem., 2, 2881-2885 (1982); Inorg. Chem., 18, 2023-2025 (1979); Inorg. Synthesis, 173-176 (1960); and Journal of Physical Chemistry, 56, 22-25 (1952).

Transition Metal Complexes of Macropolycyclic Rigid Ligands—Compositions herein may also suitably include as bleach catalyst a transition metal complex of a macropolycyclic rigid ligand. The amount used is a catalytically effective amount, suitably about 1 ppb or more, for example up to about 99.9%, more typically about 0.001 ppm or more, preferably from about 0.05 ppm to about 500 ppm (wherein “ppb” denotes parts per billion by weight and “ppm” denotes parts per million by weight).

Transition-metal bleach catalysts of Macrocyclic Rigid Ligands which are suitable for use in the invention compositions include:
Dichloro-5,12-dimethyl-1,5,8,12-tetraazabicyclo[6.6.2]hexadecane Manganese(II)
Dichloro-5,12-diethyl-1,5,8,12-tetraazabicyclo[6.6.2]hexadecane Manganese(II)
Diaquo-5,12-dimethyl-1,5,8,12-tetraazabicyclo[6.6.2]hexadecane Manganese(II) Hexafluorophosphate
Diaquo-5,12-diethyl-1,5,8,12-tetraazabicyclo[6.6.2]hexadecane Manganese(II) Hexafluorophosphate
Aquo-hydroxy-S, 12-dimethyl-1,5,8,12-tetraazabicyclo[6.6.2]hexadecane Manganese(III) Hexafluorophosphate
Diaquo-5,12-dimethyl-1,5,8,12-tetraazabicyclo[6.6.2]hexadecane Manganese(II) Tetrafluoroborate
Dichloro-5,12-dimethyl-1,5,8,12 tetraazabicyclo[6.6.2]hexadecane Manganese(III) Hexafluorophosphate
Dichloro-5,12-diethyl-1,5,8,12-tetraazabicyclo[6.6.2]hexadecane Manganese(III) Hexafluorophosphate
Dichloro-5,12-di-n-butyl-1,5,8,12-tetraaza bicyclo[6.6.2]hexadecane Manganese(II)
Dichloro-5,12-dibenzyl-1,5,8,12-tetraazabicyclo[6.6.2]hexadecane Manganese(II)
Dichloro-5-n-butyl-12-methyl-1,5,8,12-tetraaza-bicyclo[6.6.2]hexadecane Manganese(II)
Dichloro-5-n-octyl-12-methyl-1,5,8,12-tetraaza-bicyclo[6.6.2]hexadecane Manganese(II)
Dichloro-5-n-butyl-12-methyl-1,5,8,12-tetraaza-bicyclo[6.6.2]hexadecane Manganese(II).

As a practical matter, and not by way of limitation, the compositions and methods herein can be adjusted to provide on the order of at least one part per hundred million of the active bleach catalyst species in the composition, and will preferably provide from 0.01 ppm to 25 ppm, more preferably from 0.05 ppm to 10 ppm, and most preferably from 0.1 ppm to 5 ppm, of the bleach catalyst species in the composition.

The Detergent Composition

The detergent compositions of the present invention may also contain additional detergent components. The precise nature of these additional components, and levels of incorporation thereof will depend on the physical form of the composition, and the nature of the cleaning operation for which it is to be used.

The cleaning compositions preferably further comprise another enzyme to produce in situ mono-carbohydrates as substrate for the carbohydrate oxidase. Those are selected from the group consisting of amylase, protease, lipase, cellulase, hemicellulase, pectin degrading enzyme, mannanase and/or glucanase enzyme. Indeed amylase, cellulase, hemicellulase, pectin degrading enzyme, and/or glucanase enzymes can hydrolyze soils (starch, sugar, pectins, cellulose, hemi-celluose, glucane) present in the washload (dishware or fabric) into mono-, di-, tri- and other oligomers, providing additional substrate for the carbohydrate oxidase. Proteases and lipases can enhance the above substrate generation process by breaking down lipid and protein layers in the cell walls of the targeted soils.

These other enzymes can be included in the composition of the present invention at a level of from 0.0001% to 2%, preferably 0.001% to 0.2%, more preferably 0.005% to 0.1% pure enzyme by weight of the total composition.

Proteases are subtilisins from Bacillus [e.g. subtilis, lentus, licheniformis, amyloliquefaciens (BPN, BPN), alcalophilus,] e.g. Esperase®, Alcalase®, Everlase® and Savinase® (Novozymes), BLAP and variants [Henkel]. Further proteases are described in EP130756, WO91/06637, WO95/10591 and WO99/20726. Amylases (α and/or β) are described in WO 94/02597 and WO 96/23873. Commercial examples are Purafect Ox Am® [Genencor] and Termamyl®, Natalase®, Ban®, Fungamyl® and Duramyl® [all ex Novozymes]. Cellulases include bacterial or fungal cellulases, e.g. produced by Humicola insolens, particularly DSM 1800, e.g. 50 Kda and ⁻43 kD [Carezyme®]. Also suitable cellulases are the EGIII cellulases from Trichoderma longibrachiatum. Suitable lipases include those produced by Pseudomonas and Chromobacter groups. Preferred are e.g. Lipolase^{R}, Lipolase Ultra^{R}, Lipoprime^{R} and Lipex^{R} from Novozymes. Also suitable are cutinases [EC 3.1.1.50] and esterases. Carbohydrases e.g. mannanase (US6060299), pectate lyase (WO99/27083) cyclomaltodextringlucanotransferase (WO96/33267) xyloglucanase (WO99/02663). Bleaching enzymes eventually with enhancers include e.g. peroxidases, laccases, oxygenases, (e.g. catechol 1,2 dioxygenase, lipoxygenase (WO 95/26393), (non-heme) haloperoxidases.

Enzymes can be stabilized using any known stabilizer system like calcium and/or magnesium compounds, boron compounds and substituted boric acids, aromatic borate esters, peptides and peptide derivatives, polyols, low molecular weight carboxylates, relatively hydrophobic organic compounds [e.g. certain esters, diakyl glycol ethers, alcohols or alcohol alkoxylates], alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compound, polyamide oligomer, glycolic acid or its salts; poly hexa methylene bi guanide or N,N-bis-3-amino-propyl-dodecyl amine or salt; and mixtures thereof. In liquid matrix, the degradation by the proteolytic enzyme of second enzymes can be avoided by protease reversible inhibitors [e.g. peptide or protein type, in particular the modified subtilisin inhibitor of family VI and the plasminostrepin; leupeptin, peptide trifluoromethyl ketones, peptide aldehydes.

The detergent can be any suitable detergent known in the art and preferably comprises one or more surfactants, dispersants, balance carriers and adjunct ingredients. Indeed, the detergent compositions herein include laundry detergents as well as hard surface cleaners, hand dishwashing or automatic dishwashing detergents. The detergent compositions herein can be liquid, paste, gels, bars, tablets, spray, foam, powder or granular. Granular compositions can also be in “compact” form and the liquid compositions can also be in a “concentrated” form. Tablet compositions can be in single phase or multiple phase form. Liquid detergent compositions in a “concentrated form” will contain a lower amount of water, compared to conventional liquid detergents. Typically the water content of the concentrated liquid detergent is preferably less than 40%, more preferably less than 30%, most preferably less than 20% by weight of the detergent composition.

When formulated as compositions for use in manual dishwashing methods the compositions herein typically contain a surfactant and preferably other detergent metal ions, solvents, hydrotropes and additional enzymes.

When formulated as compositions suitable for use in a laundry machine washing method, the compositions herein typically contain both a surfactant and a builder compound and additionally one or more detergent components preferably selected from organic polymeric compounds, bleaching agents, additional enzymes, suds suppressors, dispersants, lime-soap dispersants, soil suspension and anti-redeposition agents and corrosion inhibitors. Laundry compositions can also contain softening agents, as additional detergent components.

When formulated as compositions suitable for use in a machine dishwashing method, the compositions herein typically contain a surfactant, in particular a low foaming nonionic surfactant, a builder system, and one or more components preferably selected from organic polymeric compounds, bleaching agents, additional enzymes, suds suppressors, dispersants, lime-soap dispersants, soil suspension and anti-redeposition agents and corrosion inhibitors.

The compositions herein can also be used as detergent additive products in solid or liquid form. Such additive products are intended to supplement or boost the performance of conventional detergent compositions and can be added at any stage of the cleaning process.

Other components used in detergent compositions may be employed, such as metallo catalyst for

colour maintenance, fabric softening agents, iron and/or manganese chelating agents, soil-suspending agents, soil-release agents, optical brighteners, abrasives, bactericides, tarnish inhibitors, suds suppressors, dye transfer inhibitors, colouring agents, and/or encapsulated or non-encapsulated perfumes, dispersants.

The compositions of the invention may be used in essentially any washing or cleaning methods, including soaking methods, pre-treatment methods and methods with rinsing steps for which a separate rinse aid composition may be added.

The process described herein comprises contacting fabrics, dishware or any other hard surface with a cleaning solution in the usual manner and exemplified hereunder. A conventional laundry method comprises treating soiled fabric with an aqueous liquid having dissolved or dispensed therein an effective amount of the laundry detergent and/or fabric care composition. A preferred machine dishwashing method comprises treating soiled articles with an aqueous liquid having dissolved or dispensed therein an effective amount of the machine dishwashing or rinsing composition. A conventional effective amount of the machine dishwashing composition means from 8-60 g of product dissolved or dispersed in a wash volume from 3-10 litres. According to a manual dishwashing method, soiled dishes are contacted with an effective amount of the dishwashing composition, typically from 0.5-20 g (per 25 dishes being treated). Preferred manual dishwashing methods include the application of a concentrated solution to the surfaces of the dishes or the soaking in large volume of dilute solution of the detergent composition. A conventional hard surface method comprises treating soiled hard items/surfaces with e.g. a sponge, brush, clothe, etc. with an aqueous liquid having dissolved or dispensed therein an effective amount of the hard surface cleaner and/or with such composition undiluted. It also encompasses the soaking of a hard item in a concentrated solution or in a large volume of dilute solution of the detergent composition.

The process of the invention is conveniently carried out in the course of the cleaning process. The method of cleaning is preferably carried out at 5° C. to 95° C., especially between 10° C. and 60° C. The pH of the treatment solution is preferably from 7 to 12.

### EXAMPLES

In the exemplified detergent compositions, the enzymes levels are expressed by pure enzyme by weight of the total composition and unless otherwise specified, the detergent ingredients are expressed by weight of the total compositions. The abbreviated component identifications therein have the following meanings:
LAS: Sodium linear C₁₁₋₁₃ alkyl benzene sulphonate.
TAS: Sodium tallow alkyl sulphate.
CxyAS: Sodium C₁ₓ-C_{1y} alkyl sulfate.
CxyEz: C₁ₓ-C_{1y} predominantly linear primary alcohol condensed with an average of z moles of ethylene oxide.
CxyAEzS: C₁ₓ-C_{1y} sodium alkyl sulfate condensed with an average of z moles of ethylene oxide. Added molecule name in the examples.
Nonionic: Mixed ethoxylated/propoxylated fatty alcohol e.g. Plurafac LF404 being an alcohol with an average degree of ethoxylation of 3.8 and an average degree of propoxylation of 4.5.
QAS: R₂.N+(CH₃)₂(C₂H₄₀H) with R₂═C₁₂-C₁₄.
Silicate: Amorphous Sodium Silicate (SiO₂:Na₂O ratio=1.6-3.2:1).
Metasilicate: Sodium metasilicate (SiO₂:Na₂O ratio=1.0).
Zeolite A: Hydrated Aluminosilicate of formula Na₁₂(AlO₂SiO₂)₁₂. 27H₂O
SKS-6: Crystalline layered silicate of formula δ-Na₂Si₂O₅.
Sulphate: Anhydrous sodium sulphate.
STPP: Sodium Tripolyphosphate.
MA/AA: Random copolymer of 4:1 acrylate/maleate, average molecular weight about 70,000-80,000.
AA: Sodium polyacrylate polymer of average molecular weight 4,500.
Polycarboxylate: Copolymer comprising mixture of carboxylated monomers such as acrylate, maleate and methyacrylate with a MW ranging between 2,000-80,000 such as Sokolan commercially available from BASF, being a copolymer of acrylic acid, MW4,500.
BB1: 3-(3,4-Dihydroisoquinolinium)propane sulfonate
BB2: 1-(3,4-dihydroisoquinolinium)-decane-2-sulfate
PB1: Sodium perborate monohydrate.
PB4: Sodium perborate tetrahydrate of nominal formula NaBO₃.4H₂O.
Percarbonate: Sodium percarbonate of nominal formula 2Na₂CO₃.3H₂O₂.
TAED: Tetraacetyl ethylene diamine.
NOBS: Nonanoyloxybenzene sulfonate in the form of the sodium salt.
DTPA: Diethylene triamine pentaacetic acid.
HEDP: 1,1-hydroxyethane diphosphonic acid.
DETPMP: Diethyltriamine penta (methylene) phosphonate, marketed by Monsanto under the Trade name Dequest 2060.
EDDS: Ethylenediamine-N,N′-disuccinic acid, (S,S) isomer in the form of its sodium salt
Diamine: Dimethyl aminopropyl amine; 1,6-hezane diamine; 1,3-propane diamine; 2-methyl-1,5-pentane diamine; 1,3-pentanediamine; 1-methyl-diaminopropane.
DETBCHD 5,12-diethyl-1,5,8,12-tetraazabicyclo [6,6,2] hexadecane, dichloride, Mn(II) salt
PAAC: Pentaamine acetate cobalt(III) salt.
Paraffin: Paraffin oil sold under the tradename Winog 70 by Wintershall.
Paraffin Sulfonate: A Paraffin oil or wax in which some of the hydrogen atoms have been replaced by sulfonate groups.
Aldose oxidase: Aldose oxidase produced by Microdochium nivale CBS 100236 and having the amino acid sequence described in SEQ ID NO:2 of WO99/31990 published on Jul. 1, 1999 By Novo Nordisk A/S
Galactose oxidase: Galactose oxidase from Sigma
Protease: Proteolytic enzyme sold under the tradename Savinase, Alcalase, Everlase by Novo Nordisk A/S, and the following from Genencor International, Inc: “Protease A” described in US RE 34,606 in FIGS. 1A, 1B, and 7, and at column 11, lines 11-37; “Protease B” described in U.S. Pat. No. 5,955,340 and U.S. Pat. No. 5,700,676 in FIGS. 1A, 1B and 5, as well as Table 1; and “Protease C” described in U.S. Pat. No. 6,312,936 and U.S. Pat. No. 6,482,628 in FIGS. 1-3 [SEQ ID 3], and at column 25, line 12, “Protease D” being the variant 101G/103A/1041/159D/232V/236H/245R/248D/252K (BPN′ numbering) described in WO 99/20723.
Haloperoxidase Curvularia verruculosa haloperoxidase having the DNA sequence (SEQ No.1) and the deduced amino acid sequence (SEQ No.2) described in FIG. 10 of WO97/04102 published by Novo Nordisk A/S on Feb. 6, 1997.
Amylase: Amylolytic enzyme sold under the tradename Purafact Ox Am^{R} described in WO 94/18314, WO96/05295 sold by Genencor; Natalase®, Termamyl®, Fungamyl® and Duramyl®, all available from Novozymes A/S.
Lipase: Lipolytic enzyme sold under the tradename Lipolase Lipolase Ultra by Novozymes A/S and Lipomax by Gist-Brocades.
Cellulase: Cellulytic enzyme sold under the tradename Carezyme, Celluzyme and/or Endolase by Novozymes A/S.
Pectin Lyase: Pectaway® and Pectawash® available from Novozymes A/S.
PVP: Polyvinylpyrrolidone with an average molecular weight of 60,000
PVNO: Polyvinylpyridine-N-Oxide, with an average molecular weight of 50,000.
PVPVI: Copolymer of vinylimidazole and vinylpyrrolidone, with an average molecular weight of 20,000.
Brightener 1: Disodium 4,4′-bis(2-sulphostyryl)biphenyl.
Silicone antifoam: Polydimethylsiloxane foam controller with siloxane-oxyalkylene copolymer as dispersing agent with a ratio of said foam controller to said dispersing agent of 10:1 to 100:1.
Suds Suppressor: 12% Silicone/silica, 18% stearyl alcohol,70% starch in granular form.
SRP 1: Anionically end capped poly esters.
PEG X: Polyethylene glycol, of a molecular weight of x.
PVP K60®: Vinylpyrrolidone homopolymer (average MW 160,000)
Jeffamine® ED-2001: Capped polyethylene glycol from Huntsman
Isachem® AS: A branched alcohol alkyl sulphate from Enichem
MME PEG (2000): Monomethyl ether polyethylene glycol (MW 2000) from Fluka Chemie AG.
DC3225C: Silicone suds suppresser, mixture of Silicone oil and Silica from Dow Corning.
TEPAE: Tetreaethylenepentaamine ethoxylate.
BTA: Benzotriazole.
Betaine: (CH₃)₃N⁺CH₂COO⁻
Sugar: Industry grade D-glucose or food grade sugar
CFAA: C₁₂-C₁₄ alkyl N-methyl glucamide
TPKFA: C12-C14 topped whole cut fatty acids.
PH: Measured as a 1% solution in distilled water at 20° C.

### Example 1

The following liquid laundry detergent compositions are prepared in accordance with the present invention.

| | I | II | III | IV | V |
|---|---|---|---|---|---|
| LAS | 18.0 | — | — | — | — |
| C₂₅ AES | — | 2.0 | 8.0 | 11.0 | 5.0 |
| C₈-C₁₀ propyl dimethyl | 2.0 | 2.0 | 2.0 | 2.0 | 1.0 |
| amine | | | | | |
| C₁₂-C₁₄ alkyl dimethyl | — | — | — | — | 2.0 |
| amine oxide | | | | | |
| C₂₅ AS | — | 17.0 | 17.0 | 7.0 | 8.0 |
| CFAA | — | 5.0 | 4.0 | 4.0 | 3.0 |
| C₁₂-C₁₄ Fatty alcohol | 12.0 | 6.0 | 1.0 | 1.0 | 1.0 |
| ethoxylate | | | | | |
| C₁₂-C₁₈ Fatty acid | 11.0 | 11.0 | 4.0 | 4.0 | 3.0 |
| Citric acid anhydrous | 5.0 | 1.0 | 3.0 | 3.0 | 2.0 |
| DETPMP | 1.0 | 1.0 | 1.0 | 1.0 | 0.5 |
| Monoethanolamine | 11.0 | 8.0 | 5.0 | 5.0 | 2.0 |
| Sodium hydroxide | 1.0 | 1.0 | 2.5 | 1.0 | 1.5 |
| Propanediol | 12.7 | 14.5 | 13.1 | 10. | 08.0 |
| Ethanol | 1.8 | 1.8 | 4.7 | 5.4 | 1.0 |
| Pectin Lyase | — | — | — | 0.005 | — |
| Amylase | — | 0.002 | — | | — |
| Cellulase | — | — | 0.0002 | | 0.0001 |
| Lipase | 0.1 | — | 0.1 | — | 0.1 |
| Protease A | 0.05 | 0.3 | 0.055 | 0.5 | 0.2 |
| Aldose Oxidase | 0.03 | 0.03 | 0.3 | 0.3 | 0.003 |
| PAAC | 0.01 | 0.01 | — | — | — |
| DETBCHD | — | — | 0.02 | 0.01 | — |
| Haloperoxidase | — | — | — | — | 0.01 |
| SRP1 | 0.5 | 0.5 | — | 0.3 | 0.3 |
| Boric acid | 2.4 | 2.4 | 2.8 | 2.8 | 2.4 |
| Sodium xylene sulfonate | — | — | 3.0 | — | — |
| DC 3225C | 1.0 | 1.0 | 1.0 | 1.0 | 1.0 |
| 2-butyl-octanol | 0.03 | 0.04 | 0.04 | 0.03 | 0.03 |

| | |
|---|---|
| Minors and water | Up to 100% |

### Example 2

The following hand dish liquid detergent compositions are prepared in accordance with the present invention.

| | I | II | III | IV | V | VI |
|---|---|---|---|---|---|---|
| AES | 30.0 | 28.0 | 25.0 | — | 15.0 | 10.0 |
| LAS | — | — | — | 5.0 | 15.0 | 12.0 |
| Paraffin Sulfonate | — | — | — | 20.0 | — | — |
| C10-C18 Alkyl Dimethyl | 5.0 | 3.0 | 7.0 | — | — | — |
| Amine Oxide | | | | | | |
| Betaine | 3.0 | — | 1.0 | 3.0 | 1.0 | — |
| C12 poly-OH fatty acid | — | — | — | 3.0 | — | 1.0 |
| amide | | | | | | |
| C14 poly-OH fatty acid | — | 1.5 | — | — | — | — |
| amide | | | | | | |
| C11E9 | 2.0 | — | 4.0 | — | — | 20.0 |
| DTPA | — | — | — | — | 0.2 | — |
| Tri-sodium Citrate dihydrate | 0.25 | — | — | 0.7 | — | — |
| Diamine | 1.0 | 5.0 | 7.0 | 1.0 | 5.0 | 7.0 |
| MgC12 | 0.25 | — | — | 1.0 | — | — |
| Protease A | 0.02 | 0.01 | 0.02 | 0.01 | 0.02 | 0.05 |
| Amylase | 0.001 | — | — | 0.002 | — | 0.001 |
| Aldose Oxidase | 0.03 | 0.01 | 0.02 | 0.03 | 0.05 | 0.03 |
| Sodium Cumene Sulphonate | — | — | — | 2.0 | 1.5 | 3.0 |
| PAAC | 0.01 | 0.01 | 0.02 | — | — | — |
| DETBCHD | — | — | — | 0.01 | 0.02 | 0.01 |
| pH 10% | 9 | 10 | 10 | 9.3 | 8.5 | 11 |

| | |
|---|---|
| Minors and water | Up to 100% |

### Example 3

The following liquid automatic dishwashing detergent compositions are prepared in accordance with the present invention.

| | I | II | III | IV | V | VI |
|---|---|---|---|---|---|---|
| STPP | 16 | 16 | 18 | 16 | 16 | 18 |
| Potassium Sulfate | — | 10 | 8 | — | 10 | 8 |
| 1,2 propanediol | 6.0 | 0.5 | 2.0 | 6.0 | 0.5 | 2.0 |
| Boric Acid | 4.0 | 3.0 | 3.0 | 4.0 | 3.0 | 3.0 |
| CaCl₂ dihydrate | 0.04 | 0.04 | 0.04 | 0.04 | 0.04 | 0.04 |
| Nonionic | 0.5 | 0.5 | 0.5 | 0.5 | 0.5 | 0.5 |
| Protease B | 0.03 | 0.03 | 0.03 | 0.03 | 0.03 | 0.03 |
| Amylase | 0.02 | — | 0.02 | 0.02 | — | 0.02 |
| Aldose Oxidase | 0.0008 | 0.15 | 0.02 | — | 0.01 | — |
| Galactose Oxidase | — | — | 0.01 | 0.025 | 0.01 | 0.03 |
| PAAC | 0.01 | — | — | 0.01 | — | — |
| DETBCHD | — | 0.01 | — | — | 0.01 | — |
| Haloperoxidase | — | — | 0.01 | — | — | 0.01 |

| | |
|---|---|
| Minors and water | Up to100% |

### Example 4

The following laundry compositions, which may be in the form of granules or tablet, were prepared according to the present invention.

| Base Product | I | II | III | IV | V |
|---|---|---|---|---|---|
| C45AS/TAS | 8.0 | 5.0 | 3.0 | 3.0 | 3.0 |
| LAS | 8.0 | — | 8.0 | — | 7.0 |
| C25AE3S | 0.5 | 2.0 | 1.0 | — | — |
| C25AE5/AE3 | 2.0 | — | 5.0 | 2.0 | 2.0 |
| QAS | — | — | — | 1.0 | 1.0 |
| Zeolite A | 20.0 | 18.0 | 11.0 | — | 10.0 |
| SKS-6 (dry add) | — | — | 9.0 | — | — |
| MA/AA | 2.0 | 2.0 | 2.0 | — | — |
| AA | — | — | — | — | 4.0 |
| 3Na Citrate 2H₂O | — | 2.0 | — | — | — |
| Anhydrous Citric acid | 2.0 | — | 1.5 | 2.0 | — |
| DTPA | 0.2 | 0.2 | — | — | — |
| EDDS | — | — | 0.5 | 0.1 | — |
| HEDP | — | — | 0.2 | 0.1 | — |
| PB1 | 3.0 | — | — | — | 4.0 |
| Percarbonate | — | — | — | 18.0 | — |
| NOBS | 3.0 | — | — | — | — |
| NACA OBS | — | — | 2.0 | — | — |
| TAED | — | — | 2.0 | 5.0 | — |
| BB1 | 0.06 | — | 0.34 | — | 0.14 |
| BB2 | — | 0.14 | — | 0.20 | — |
| Anhydrous Na | 15.0 | 18.0 | 8.0 | 15.0 | 15.0 |
| Carbonate | | | | | |
| Sulphate | 5.0 | 12.0 | 2.0 | 17.0 | 3.0 |
| Silicate | — | 1.0 | — | — | 8.0 |
| Protease B | 0.033 | 0.033 | — | — | — |
| Protease C | — | — | 0.033 | 0.046 | 0.033 |
| Lipase | — | 0.008 | — | — | — |
| Amylase | 0.001 | — | — | — | 0.001 |
| Cellulase | — | 0.0014 | — | — | — |
| Pectin Lyase | 0.001 | 0.001 | 0.001 | 0.001 | 0.001 |
| Aldose Oxidase | 0.03 | 0.03 | 0.05 | 0.05 | 0.01 |
| PAAC | — | 0.01 | — | — | 0.05 |
| Haloperoxidase | — | — | 0.01 | 0.02 | — |
| Sugar | — | 3.0 | — | — | 1.0 |

| | |
|---|---|
| Moisture and Minors | Up to 100% |

Minors include Brightener/SRP1/Na Carboxymethylcellulose/Photobleach/MgSO4/PVPVI/Suds suppressor/PEG.

### Example 5

The following liquid laundry detergent formulations were prepared according to the present invention (Levels are given in parts per weight, enzyme are expressed in pure enzyme)

| | I | I | II | III | IV | V |
|---|---|---|---|---|---|---|
| LAS | 11.5 | 11.5 | 9.0 | — | 4.0 | — |
| C25E2.5S | — | — | 3.0 | 18.0 | — | 16.0 |
| C45E2.25S | 11.5 | 11.5 | 3.0 | — | 16.0 | — |
| C23E9 | — | — | 3.0 | 2.0 | 2.0 | 1.0 |
| C23E7 | 3.2 | 3.2 | — | — | — | — |
| CFAA | — | — | — | 5.0 | — | 3.0 |
| TPKFA | 2.0 | 2.0 | — | 2.0 | 0.5 | 2.0 |
| Anhydr. citric acid | 3.2 | 3.2 | 0.5 | 1.2 | 2.0 | 1.2 |
| Ca formate | 0.1 | 0.1 | 0.06 | 0.1 | — | — |
| Na formate | 0.5 | 0.5 | 0.06 | 0.1 | 0.05 | 0.05 |
| Na Culmene | 4.0 | 4.0 | 1.0 | 3.0 | 1.2 | — |
| sulfonate | | | | | | |
| Borate | 0.6 | 0.6 | — | 3.0 | 2.0 | 3.0 |
| Na hydroxide | 6.0 | 6.0 | 2.0 | 3.5 | 4.0 | 3.0 |
| Ethanol | 2.0 | 2.0 | 1.0 | 4.0 | 4.0 | 3.0 |
| 1,2 Propanediol | 3.0 | 3.0 | 2.0 | 8.0 | 8.0 | 5.0 |
| Monoethanolamine | 3.0 | 3.0 | 1.5 | 1.0 | 2.5 | 1.0 |
| TEPAE | 2.0 | 2.0 | — | 1.0 | 1.0 | 1.0 |
| Protease A | 0.03 | 0.03 | 0.01 | 0.03 | 0.02 | 0.02 |
| Lipase | — | — | — | 0.002 | — | — |
| Amylase | — | — | — | — | 0.002 | — |
| Cellulase | — | — | — | — | — | 0.0001 |
| Pectin Lyase | 0.005 | 0.005 | — | | — | — |
| Aldose Oxidase | 0.05 | — | 0.03 | 0.05 | 0.02 | 0.02 |
| Galactose oxidase | — | 0.04 | — | — | — | — |
| PAAC | 0.03 | 0.03 | 0.02 | — | — | — |
| DETBCHD | — | — | — | 0.02 | 0.01 | — |
| Haloperoxidase | — | — | — | — | — | 0.01 |
| SRP 1 | 0.2 | 0.2 | — | 0.1 | — | — |
| DTPA | — | — | — | 0.3 | — | — |
| PVNO | — | — | — | 0.3 | — | 0.2 |
| Brightener 1 | 0.2 | 0.2 | 0.07 | 0.1 | — | — |
| Silicone antifoam | 0.04 | 0.04 | 0.02 | 0.1 | 0.1 | 0.1 |

| | |
|---|---|
| Miscellaneous and | Up to 100% |
| water | |

### Example 6

The following compact high density (0.96 Kg/l) dishwashing detergent compositions were prepared according to the present invention:

| | I | II | III | IV | V | VI |
|---|---|---|---|---|---|---|
| STPP | — | 45.0 | 45.0 | — | — | 40.0 |
| 3Na Citrate | 17.0 | — | — | 50.0 | 40.2 | — |
| 2H₂O | | | | | | |
| Na Carbonate | 17.5 | 14.0 | 20.0 | — | 8.0 | 33.6 |
| Bicarbonate | — | — | — | 26.0 | — | — |
| Silicate | 15.0 | 15.0 | 8.0 | — | 25.0 | 3.6 |
| Metasilicate | 2.5 | 4.5 | 4.5 | — | — | — |
| PB1 | — | — | 4.5 | — | — | — |
| PB4 | — | — | — | 5.0 | — | — |
| Percarbonate | — | — | — | — | — | 4.8 |
| BB1 | — | 0.1 | 0.1 | — | 0.5 | — |
| BB2 | 0.2 | 0.05 | — | 0.1 | — | 0.6 |
| Nonionic | 2.0 | 1.5 | 1.5 | 3.0 | 1.9 | 5.9 |
| HEDP | 1.0 | — | — | — | — | — |
| DETPMP | 0.6 | — | — | — | — | — |
| Haloperoxidase | — | — | — | 0.03 | 0.02 | 0.01 |
| PAAC | 0.03 | 0.05 | 0.02 | — | — | — |
| Paraffin | 0.5 | 0.4 | 0.4 | 0.6 | — | — |
| Protease B | 0.072 | 0.053 | 0.053 | 0.026 | 0.059 | 0.01 |
| Amylase | 0.012 | — | 0.012 | — | 0.021 | 0.006 |
| Lipase | — | 0.001 | — | 0.005 | — | — |
| Pectin Lyase | 0.001 | 0.001 | 0.001 | — | — | — |
| Aldose Oxidase | 0.05 | 0.05 | 0.03 | 0.01 | 0.02 | 0.01 |
| BTA | 0.3 | 0.2 | 0.2 | 0.3 | 0.3 | 0.3 |
| Poly- | 6.0 | — | — | — | 4.0 | 0.9 |
| carboxylate | | | | | | |
| Perfume | 0.2 | 0.1 | 0.1 | 0.2 | 0.2 | 0.2 |
| pH | 11.0 | 11.0 | 11.3 | 9.6 | 10.8 | 10.9 |

| | |
|---|---|
| Miscellaneous, | Up to 100% |
| sulfate and | |
| water | |

### Example 7

The following tablet detergent compositions were prepared according to the present invention by compression of a granular dishwashing detergent composition at a pressure of 13KN/cm² using a standard 12 head rotary press:

| | I | II | III | IV | V | VI | VII | VIII |
|---|---|---|---|---|---|---|---|---|
| STPP | — | 48.8 | 54.7 | 38.2 | — | 52.4 | 56.1 | 36.0 |
| 3Na Citrate 2H₂O | 20.0 | — | — | — | 35.9 | — | — | — |
| Na Carbonate | 20.0 | 5.0 | 14.0 | 15.4 | 8.0 | 23.0 | 20.0 | 28.0 |
| Silicate | 15.0 | 14.8 | 15.0 | 12.6 | 23.4 | 2.9 | 4.3 | 4.2 |
| Lipase | 0.001 | — | 0.01 | — | 0.02 | — | — | — |
| Protease B | 0.042 | 0.072 | 0.042 | 0.031 | — | — | — | — |
| Protease C | — | — | — | — | 0.052 | 0.023 | 0.023 | 0.029 |
| Amylase | 0.012 | 0.012 | 0.012 | — | 0.015 | — | 0.017 | 0.002 |
| Pectin Lyase | 0.005 | — | — | 0.002 | — | — | — | — |
| Aldose Oxidase | ‘0.05 | 0.03 | 0.03 | 0.02 | 0.02 | 0.01 | 0.03 | 0.01 |
| PB1 | — | — | — | — | — | — | — | 8.5 |
| Percarbonate | — | — | — | — | — | 5.0 | — | — |
| BB1 | 0.2 | — | 0.5 | — | 0.3 | 0.2 | — | — |
| BB2 | — | 0.2 | — | 0.5 | — | — | 0.1 | 0.2 |
| Nonionic | 1.5 | 2.0 | 2.0 | 2.2 | 1.0 | 4.2 | 4.0 | 6.5 |
| PAAC | 0.01 | 0.01 | 0.02 | — | — | — | — | — |
| DETBCHD | — | — | — | 0.02 | 0.02 | — | — | — |
| Haloperoxidase | — | — | — | — | — | — | 0.02 | — |
| TAED | — | — | — | — | — | 2.1 | — | 1.6 |
| HEDP | 1.0 | — | — | 0.9 | — | 0.4 | 0.2 | — |
| DETPMP | 0.7 | — | — | — | — | — | — | — |
| Paraffin | 0.4 | 0.5 | 0.5 | 0.5 | — | — | 0.5 | — |
| BTA | 0.2 | 0.3 | 0.3 | 0.3 | 0.3 | 0.3 | 0.3 | — |
| Polycarboxylate | 4.0 | — | — | — | 4.9 | 0.6 | 0.8 | — |
| PEG 400-30.000 | — | — | — | — | — | 2.0 | — | 2.0 |
| Glycerol | — | — | — | — | — | 0.4 | — | 0.5 |
| Perfume | — | — | — | 0.05 | 0.2 | 0.2 | 0.2 | 0.2 |
| Weight of tablet | 20 g | 25 g | 20 g | 30 g | 18 g | 20 g | 25 g | 24 g |
| pH | 10.7 | 10.6 | 10.7 | 10.7 | 10.9 | 11.2 | 11.0 | 10.8 |

| | |
|---|---|
| Miscellaneous, | Up to 100% |
| sulfate and | |
| water | |

### Example 8

The following liquid hard surface cleaning detergent compositions were prepared according to the present invention:

| | I | II | III | IV | V | VI | VII |
|---|---|---|---|---|---|---|---|
| C9-11 E5 | 2.4 | 1.9 | 2.5 | 2.5 | 2.5 | 2.4 | 2.5 |
| C12-14 E5 | 3.6 | 2.9 | 2.5 | 2.5 | 2.5 | 3.6 | 2.5 |
| C7-9 E6 | — | — | — | — | 8.0 | — | — |
| C₁₂₋₁₄ E21 | 1.0 | 0.8 | 4.0 | 2.0 | 2.0 | 1.0 | 2.0 |
| LAS | — | — | — | 0.8 | 0.8 | — | 0.8 |
| Sodium culmene sulfonate | 1.5 | 2.6 | — | 1.5 | 1.5 | 1.5 | 1.5 |
| Isachem ® AS | 0.6 | 0.6 | — | — | — | 0.6 | — |
| Na2CO3 | 0.6 | 0.13 | 0.6 | 0.1 | 0.2 | 0.6 | 0.2 |
| 3Na Citrate 2H₂O | 0.5 | 0.56 | 0.5 | 0.6 | 0.75 | 0.5 | 0.75 |
| NaOH | 0.3 | 0.33 | 0.3 | 0.3 | 0.5 | 0.3 | 0.5 |
| Fatty Acid | 0.6 | 0.13 | 0.6 | 0.1 | 0.4 | 0.6 | 0.4 |
| 2-butyl octanol | 0.3 | 0.3 | — | 0.3 | 0.3 | 0.3 | 0.3 |
| PEG DME-2000 ® | 0.4 | — | 0.3 | 0.35 | 0.5 | — | — |
| PVP | 0.3 | 0.4 | 0.6 | 0.3 | 0.5 | — | — |
| MME PEG (2000) ® | — | — | — | — | — | 0.5 | 0.5 |
| Jefffamine ® ED-2001 | — | 0.4 | — | — | 0.5 | — | — |
| PAAC | — | — | — | 0.03 | 0.03 | 0.03 | — |
| DETBCHD | 0.03 | 0.05 | 0.05 | — | — | — | — |
| Haloperoxidase | — | — | — | — | — | — | 0.03 |
| Protease B | 0.07 | 0.05 | 0.05 | 0.03 | 0.06 | 0.01 | 0.04 |
| Amylase | 0.12 | 0.01 | 0.01 | — | 0.02 | — | 0.01 |
| Lipase | — | 0.001 | — | 0.005 | — | 0.005 | — |
| Pectin Lyase | 0.001 | — | 0.001 | — | — | — | 0.002 |
| Aldose Oxidase | 0.05 | 0.05 | 0.03 | 0.03 | 0.02 | 0.02 | 0.05 |
| PH | 9.5 | 7.4 | 9.5 | 7.5 | 9.5 | 9.5 | 9.5 |

| | |
|---|---|
| Miscellaneous, sulfate | Up to 100% |
| and water | |

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A detergent composition comprising a carbohydrate oxidase enzyme and a bleaching catalyst; with the proviso that the carbohydrate oxidase is not a glucose oxidase.

2. A detergent composition according to claim 1 wherein the carbohydrate oxidase is selected from the group consisting of aldose oxidase, galactose oxidase, cellobiose oxidase, pyranose oxidase, sorbose oxidase, hexose oxidase and mixtures thereof.

3. A detergent composition according to claim 2 wherein the carbohydrate oxidase is selected from the group consisting of aldose oxidase, galactose oxidase and mixtures thereof.

4. A detergent composition according to claim 3 wherein the carbohydrate oxidase comprises an aldose oxidase.

5. A detergent composition according to claim 1, comprising from about 0.0001% to about 2% pure carbohydrate oxidase enzyme by weight of the total composition.

6. A detergent composition according to claim 5, comprising from about 0.001% to about 0.2% pure carbohydrate oxidase enzyme by weight of the total composition.

7. A detergent composition according to claim 6, comprising from about 0.005% to about 0.1% pure carbohydrate oxidase enzyme by weight of the total composition.

8. A detergent composition according to claim 1 wherein the bleaching catalyst is selected from the group consisting of metal-containing bleaching catalyst, bleach activator, peroxidase enzyme and mixtures thereof.

9. A detergent composition according to claim 8 wherein the bleaching catalyst comprises a metal-containing catalyst.

10. A detergent composition according to claim 9 wherein the metal-containing bleaching catalyst is selected from the group consisting of manganese or cobalt metal catalyst complexes and mixtures thereof.

11. A detergent composition according to claim 10 wherein the metal-containing bleaching catalyst is selected from 5, 12-diethyl-1,5,8,12-tetraazabicyclo [6,6,2] hexadecane dichloride, Mn(II) salt; pentaamine acetate cobalt(III) salt and mixtures thereof.

12. A detergent composition according to claim 1 comprising an enzyme selected from the group consisting of amylase, cellulase, hemi-cellulase, pectin degrading enzyme, glucanase, protease, lipase and mixtures thereof;

13. A detergent composition according to claim 12 comprising an enzyme selected from the group consisting of amylase, protease and mixtures thereof.

14. A detergent composition according to claim 1 in the form of a dishwashing composition.

15. A detergent composition according to claim 14 in the form of an automatic dishwashing composition.

16. A detergent composition according to claim 1 in the form of a liquid composition.

17. A method of cleaning, comprising the step of contacting a surface with the composition of claim 1.
